(19) United States
(12) Patent Application Publication
(10) Pub. No.: US 2011/0164672 A1
(43) Pub. Date: Jul. 7, 2011

(54) Orthogonal Multiple Description Coding

(76) Inventors: Hong Jiang, Warren, NJ (US); Kim N. Matthews, Watchung, NJ (US); Zulfiquar Sayeed, Hightstown, NJ (US); Paul A. Wilford, Bernardsville, NJ (US); Lesley J. Wu, Parsippany, NJ (US)

(21) Appl. No.: 12/652,390

(22) Filed: Jan. 5, 2010

(51) Int. Cl. H04B 1/66

(52) U.S. Cl. 375/240

(57) ABSTRACT

In one aspect, an orthogonal multiple description encoder comprises orthogonal multiple description generation circuitry configured to produce multiple descriptions of a given signal by processing the signal using respective ones of a plurality of orthogonal matrices. Each of the multiple descriptions is generated as a function of the signal and a corresponding one of the plurality of orthogonal matrices. Other aspects include an orthogonal multiple description decoder, orthogonal multiple description encoding and decoding methods, and associated computer program products.

### FIELD OF THE INVENTION

The present invention relates generally to the field of signal processing, and more particularly relates to multiple description coding of signals for transmission over a communication network or other type of communication medium.

### BACKGROUND OF THE INVENTION

In a typical multiple description coding arrangement, a given signal to be transmitted is processed in a transmitter to generate multiple descriptions of that signal, and the multiple descriptions are then transmitted over a network or other communication medium to a receiver. Each of the multiple descriptions may be viewed as corresponding to a different transmission channel subject to a different loss probability. The goal of multiple description coding is generally to provide a signal reconstruction quality at the receiver that improves as the number of received descriptions increases, without introducing excessive redundancy between the various multiple descriptions.

One known multiple description coding technique is commonly referred to as quantized frame expansion. The signal to be transmitted may be represented as an N-dimensional symbol vector x={x₁, x₂, . . . , x_{N}}. The symbol vector x is multiplied by a frame expansion transform T to generate an M-dimensional symbol vector y=Tx={y₁, y₂, . . . , y_{M}}, where the transform T is an M×N matrix and M>N. The symbol vector y is then subject to a quantization operation to form Y=Q(y). Forward error correction (FEC) and cyclic redundancy check (CRC) codes are then applied to Y before it is transmitted over a network to the receiver. At the receiver, the received signal \tilde{Y} is subject to FEC decoding and the CRC is used to detect symbol errors. The symbols with no errors are used to reconstruct an estimate of x. For additional details regarding this and other conventional multiple description coding techniques, see Vivek K Goyal, “Multiple Description Coding: Compression Meets the Network,” IEEE Signal Processing Magazine, September 2001, pp. 74-93.

Conventional multiple description coding techniques generally assume that the channels are so-called “erasure” channels. With such channels, a given symbol or other piece of data is known to the receiver to be either correct or in error, and some mechanism is needed to provide this capability, such as the above-noted FEC or CRC codes. However, the FEC or CRC codes are useful only for error detection and correction, and cannot otherwise be used to enhance the quality of a reconstructed signal when no errors occur. Use of such codes therefore represents a waste of bandwidth in any channels that do not have errors.

### SUMMARY OF THE INVENTION

Illustrative embodiments of the present invention overcome the above-described drawbacks of conventional multiple description coding by providing a technique referred to herein as orthogonal multiple description coding.

In accordance with one aspect of the invention, an orthogonal multiple description encoder comprises orthogonal multiple description generation circuitry configured to produce multiple descriptions of a given signal by processing the signal using respective ones of a plurality of orthogonal matrices. Each of the multiple descriptions is generated as a function of the signal and a corresponding one of the plurality of orthogonal matrices.

In accordance with another aspect of the invention, an orthogonal multiple description decoder comprises reconstruction circuitry configured to receive respective multiple descriptions of a given signal, and to generate an estimate of the signal by applying orthogonal matrices to respective ones of the multiple descriptions.

In one of the illustrative embodiments, the orthogonal multiple description generation circuitry generates M descriptions y⁽¹⁾ of a vector x by applying respective ones of the orthogonal matrices to the vector x in accordance with the following equation:

y⁽ⁱ⁾=U⁽ⁱ⁾x,i=1, . . . ,M.

The term “applying” as used herein in the context of applying a matrix is intended to be construed broadly so as to encompass multiplication by the matrix as in the present embodiment or other processing that utilizes the matrix.

One example of a set of orthogonal matrices suitable for use in this illustrative embodiment is the set of orthogonal matrices given by:

$${U}^{( 1 )} = I - \frac{2}{{( {v}^{( 1 )} )}^{T} {v}^{( 1 )}} {{v}^{( 1 )} ( {v}^{( 1 )} )}^{T}$$

$${U}^{( i )} = {U}^{( i - 1 )} ( I - \frac{2}{{( {v}^{( i )} )}^{T} {v}^{( i )}} {{v}^{( i )} ( {v}^{( i )} )}^{T} ) , i = 2 , … M$$

where rᵢ,i=1, 2, . . . , NM is a sequence of random numbers in a specified interval, and

$${v}^{( i )} = [ \begin{matrix}{r}_{( i - 1 ) N + 1} \\ {r}_{( i - 1 ) N + 2} \\ ⋮ \\ {r}_{( i - 1 ) N + N}\end{matrix} ] , i = 1 , … , M .$$

Other types of orthogonal matrices may be used in other illustrative embodiments of the invention. For example, the orthogonal matrices may be given by:

U=[u⁽⁰⁾,u⁽¹⁾, . . . ,u^{(N-1)}],

where u⁽ⁱ⁾,i=0, . . . , N−1 is a set of orthonormal vectors generated by applying an orthogonalization process to a sequence of vectors v⁽ⁱ⁾,i=0, 1 . . . , of length N, whose components are random numbers.

The illustrative embodiments provide significant advantages over conventional approaches. For example, in one or more of these embodiments, the orthogonal matrices introduce redundancy in such a way that the redundancy can be used not only to improve signal reconstruction quality, but also to detect and correct errors in the received signal. The multiple descriptions therefore have error detection and correction capability built into them. This avoids the need to dedicate additional bandwidth for FEC and CRC, thereby ensuring that there will be no wasted bandwidth in the absence of errors, while also providing graceful degradation in the presence of errors.

These and other features and advantages of the present invention will become more apparent from the accompanying drawings and the following detailed description.

### BRIEF DESCRIPTION OF THE DRAWINGS

FIG. 1 is a block diagram of a communication system implementing orthogonal multiple description coding in an illustrative embodiment of the invention.

FIG. 2 shows a more detailed view of a communication system implementing orthogonal multiple description coding in another embodiment of the invention.

FIG. 3 is a block diagram of a communication system comprising a multimedia server implementing multiple description coding in another embodiment of the invention.

### DETAILED DESCRIPTION OF THE INVENTION

The present invention will be illustrated herein in conjunction with exemplary communication systems, processing devices and multiple description coding techniques. It should be understood, however, that the invention is not limited to use with the particular types of systems, devices and techniques disclosed. For example, aspects of the present invention can be implemented in a wide variety of other communication system configurations, using processing devices and process steps other than those described in conjunction with the illustrative embodiments.

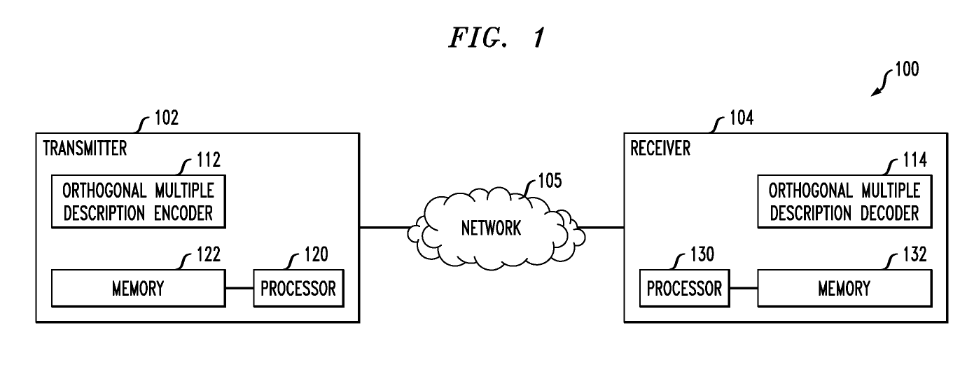

FIG. 1 shows a communication system 100 comprising a transmitter 102 coupled to a receiver 104 via a network 105. The transmitter includes an orthogonal multiple description encoder 112 and the receiver includes an orthogonal multiple description decoder 114. Also included in the transmitter 102 is a processor 120 coupled to a memory 122. Similarly, the receiver 104 comprises a processor 130 coupled to a memory 132.

The transmitter 102 may comprise at least a portion of a computer, a server or any other type of processing device suitable for supplying signals to receiver 104 over network 105. The signals supplied by the transmitter may comprise data, speech, images, video, audio or other types of signals in any combination. These signals are coded in orthogonal multiple description encoder 112 before being transmitted over the network.

The receiver 104 may comprise at least a portion of a communication device or any other type of processing device suitable for receiving signals from transmitter 102 over the network 105. For example, the receiver may be implemented in a portable or laptop computer, mobile telephone, personal digital assistant (PDA), wireless email device, television set-top box (STB), or other communication device. Signals received from the transmitter over the network 105 are decoded by the orthogonal multiple description decoder 114.

The network 105 may comprise a wide area network such as the Internet, a metropolitan area network, a local area network, a cable network, a telephone network, a satellite network, as well as portions or combinations of these or other networks.

The memories 122 and 132 may be used to store software programs that are executed by their associated processors 120 and 130 to implement the functionality described herein. For example, software running on processor 120 of transmitter 102 may be used to implement at least a portion of the orthogonal multiple description encoder 112, while software running on processor 130 of receiver 104 may be used to implement at least a portion of the orthogonal multiple description decoder 114. A given one of the memories 122 and 132 may be an electronic memory such as random access memory (RAM), read-only memory (ROM) or combinations of these and other types of storage devices. Such a memory is an example of what is more generally referred to herein as a computer program product or still more generally as a computer-readable storage medium that has executable program code embodied therein. Other examples of computer-readable storage media may include disks or other types of magnetic or optical media, in any combination.

The transmitter 102 and receiver 104 may each include additional components configured in a conventional manner. For example, each of these elements will generally include network interface circuitry for interfacing with the network 105.

The orthogonal multiple description coding utilized in system 100 of FIG. 1 generates multiple descriptions using orthogonal matrices. As will be described in greater detail below, the orthogonal matrices introduce redundancy in such a way that the redundancy can be used not only to improve signal reconstruction quality, but also to detect and correct errors in the received signal. The multiple descriptions therefore have error detection and correction capability built into them. Thus, when using orthogonal multiple description coding as disclosed herein, there is no need for an additional and separate mechanism, such as FEC and CRC, to provide error detection and correction, and no wasted bandwidth in the absence of errors. Every transmitted bit is capable of being used for both quality enhancement and error protection, such that no transmitted bits are ever wasted even when there are no errors. Also, degradation in the presence of errors is more graceful than it would otherwise be with the conventional approaches based on FEC and CRC.

As a more particular example, the network 105 may comprise a multicast or broadcast network used to transmit video from a multimedia server to multiple client devices. In this example, the orthogonal multiple description coding allows video bit streams to be transmitted to the respective client devices in such a way that all of the bits in the bit stream received by any given one of the client devices can be used by a video decoder implemented in that client device to improve reconstructed video quality.

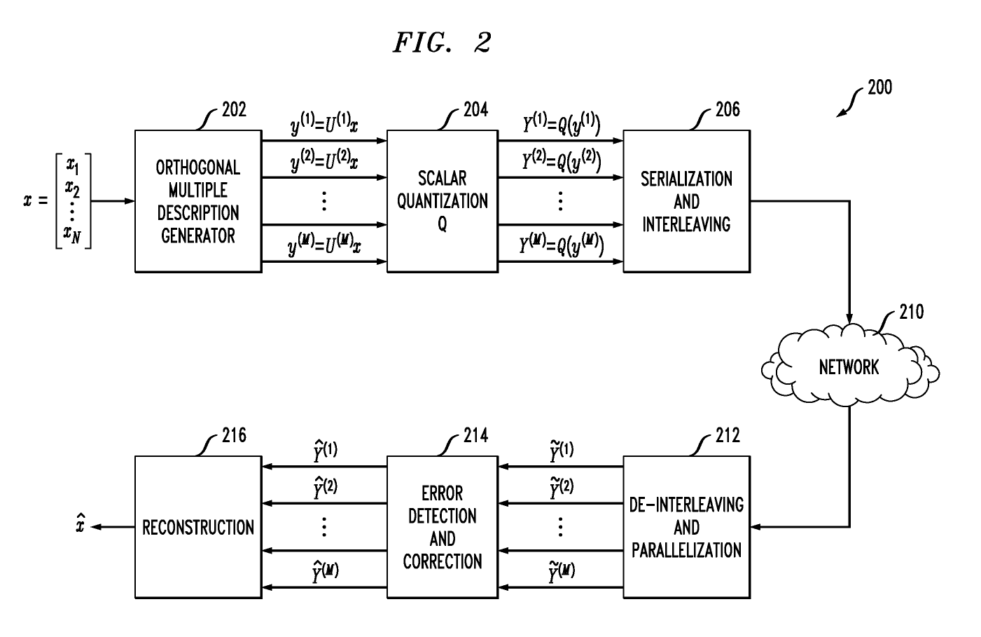

FIG. 2 shows a more detailed view of an embodiment of the invention. In this embodiment, system 200 includes a transmitter comprising an orthogonal multiple description generator module 202, a scalar quantization module 204 and a serialization and interleaving module 206. The transmitter communicates over a network 210 with a receiver comprising a de-interleaving and parallelization module 212, an error detection and correction module 214, and a reconstruction module 216. The modules 202, 204 and 206 may be viewed, for example, as collectively comprising an implementation of the orthogonal multiple description encoder 112 in transmitter 102 of FIG. 1. Similarly, the modules 212, 214 and 216 may be viewed, for example, as collectively comprising an implementation of the orthogonal multiple description decoder 114 in receiver 104 of FIG. 1.

The various modules shown in FIG. 2 may be viewed as examples of circuitry used to implement the associated functionality. Such circuitry may comprise well-known conventional encoding and decoding circuitry suitably modified to operate in the manner described herein. For example, portions of such circuitry may comprise processor and memory circuitry associated with the processors 120, 130 and memories 122, 132 of FIG. 1. Other examples include matrix multiplication circuitry or other types of arithmetic logic circuitry, digital signal processors, transceivers, etc. Conventional aspects of such circuitry are well known to those skilled in the art and therefore will not be described in detail herein.

In the FIG. 2 embodiment, x denotes a message to be transmitted, and more particularly comprises a vector of real numbers:

$$x = [ \begin{matrix}{x}_{1} \\ {x}_{2} \\ ⋮ \\ {x}_{N}\end{matrix} ]$$

For example, x may be a set of transformed coefficients generated in a speech coding, image compression or video compression process. As more particular examples for the case of JPEG image compression, x can be 8×8 DCT coefficients, x can be a row or a column of 8×8 DCT coefficients, x can be DCT coefficients of Y, Cr, Cb at one pixel, or x can be combinations of different types of such coefficients. Of course, as previously indicated, a wide variety of other types of information can be transmitted using the orthogonal multiple description coding techniques disclosed herein.

The original message x to be transmitted is applied to the orthogonal multiple description generator 202. From this original message, M messages are generated. These messages are called orthogonal multiple description messages. Each of the M messages is a description of the original message x. Any orthogonal multiple description message, or any subset of these messages, can be used to reconstruct an approximation to the original message. The more messages that are used in the reconstruction, the more accurately the reconstructed message approximates the original message.

In the present embodiment, the orthogonal multiple description messages are generated in module 202 in the following manner. Let M=2k+1 be a positive integer, and let U⁽ⁱ⁾,i=1, 2, . . . , M be orthogonal matrices of dimension N×N:

(U⁽ⁱ⁾)^{T}U⁽ⁱ⁾=U⁽ⁱ⁾(U⁽ⁱ⁾)^{T}=I,i=1, . . . ,M,

where I is the N×N identity matrix, and T indicates a matrix transpose operation. The M messages are generated by applying respective ones of the orthogonal matrices to the original message x:

y⁽ⁱ⁾=U⁽ⁱ⁾x,i=1, . . . ,M

The resulting messages are quantized in module 204 using a scalar quantization function:

Y⁽ⁱ⁾=Q(y⁽ⁱ⁾)=Q(U⁽ⁱ⁾x),i=1, . . . ,M

The quantized messages are serialized and interleaved in module 206, and transmitted over the network 210 to the receiver comprising modules 212, 214 and 216.

The data received over the network is de-interleaved and parallelized in module 212 to form received messages:

\tilde{Y}ⁱ,i=1, . . . ,M

The received messages \tilde{Y}⁽ⁱ⁾ may be different from the respective transmitted messages Y⁽ⁱ⁾ due to errors attributable to transmission through the network 210.

Error detection and correction are performed in module 214 to generate estimated messages:

Ŷ⁽ⁱ⁾,i=1, . . . ,M

The estimated messages Ŷ⁽ⁱ⁾,i=1, . . . , M are used in reconstruction module 216 to generate an estimate \hat{x} approximating the original message x.

An example of the M orthogonal matrices utilized to generate respective ones of the multiple descriptions in generator 202 will now be described in detail. An N×N matrix U is orthogonal if U^{T}U=UU^{T}=I. Let rᵢ,i=1, 2, . . . , NM be a sequence of random numbers in the interval [0,1]. Define M vectors, each of length N, by

$${v}^{( i )} = [ \begin{matrix}{r}_{( i - 1 ) N + 1} \\ {r}_{( i - 1 ) N + 2} \\ ⋮ \\ {r}_{( i - 1 ) N + N}\end{matrix} ] , i = 1 , … , M$$

The orthogonal matrices may then be computed as follows:

$${U}^{( 1 )} = I - \frac{2}{{( {v}^{( 1 )} )}^{T} {v}^{( 1 )}} {{v}^{( 1 )} ( {v}^{( 1 )} )}^{T}$$

$${U}^{( i )} = {U}^{( i - 1 )} ( I - \frac{2}{{( {v}^{( i )} )}^{T} {v}^{( i )}} {{v}^{( i )} ( {v}^{( i )} )}^{T} ) , i = 2 , … M$$

These exemplary orthogonal matrices should be known to both the transmitter and the receiver in the system 200 of FIG. 2.

It should be noted that many other techniques may be used to generate orthogonal matrices for use in orthogonal multiple description coding in embodiments of the present invention. Another exemplary technique for generating orthogonal matrices will now be described.

Let v⁽ⁱ⁾,i=0, 1 . . . , be a sequence of vectors of length N, whose components are random numbers. An orthogonalization process, such as the Gram-Schmidt process which is well-known to those skilled in the art, can be used to create a set of N orthonormal vectors u⁽ⁱ⁾,i=0, . . . , N−1. The orthonormal vectors have the property:

$${( {u}^{( i )} )}^{T} {u}^{( j )} = \{ \begin{matrix}1 , & i = j \\ 0 , & i \neq j .\end{matrix}$$

After the orthonormal vectors are created, they can be used to form the columns of an orthogonal matrix as follows:

U=[u⁽⁰⁾,u⁽¹⁾, . . . ,u^{(N-1)}].

More of such orthogonal matrices can be generated by using more sequences of vectors v⁽ⁱ⁾,i=0, 1 . . . , with random components.

Again, the foregoing techniques for generating orthogonal matrices are presented by way of illustrative example only, and numerous other orthogonal matrix generation techniques may be used in implementing the invention.

As noted above, for each orthogonal matrix U⁽ⁱ⁾, we generate y⁽ⁱ⁾=U⁽ⁱ⁾x, and y⁽ⁱ⁾ is then quantized using scalar quantization to generate transmitted messages. The transmitted messages are

Y⁽ⁱ⁾=Q(y⁽ⁱ⁾)=Q(U⁽ⁱ⁾x)=U⁽ⁱ⁾x+Δ⁽ⁱ⁾,i=1, . . . ,M

where Δ⁽ⁱ⁾=(Δ₁⁽ⁱ⁾,Δ₂⁽ⁱ⁾, . . . ,Δ_{N}⁽ⁱ⁾)^{T}, is the quantization error. Assume that Δₚ⁽ⁱ⁾,Δ_{q}^{(j)}, i≠j or p≠q, are mutually independent random variables with uniform distribution in

$$[ - \frac{1}{2} , \frac{1}{2} ] .$$

Let the variance of the quantization error in each message be

σ²=E((Δ⁽ⁱ⁾)^{T}Δ⁽ⁱ⁾),i=1, 2, . . . ,M,

where E(•) denotes expected value.

Reconstruction in the absence of error proceeds as follows. Any number of transmitted messages can be used to reconstruct the original message x. Let Y⁽ⁱ^{₁}⁾, Y⁽ⁱ^{₂}⁾, . . . , Y⁽ⁱ^{ₚ}⁾ be p transmitted messages. One example of the manner in which the original message can be reconstructed in module 216 is as follows:

$${\hat{x}}^{p} = \frac{1}{p} {\sum }_{q = 1}^{p} {( {U}^{( {i}_{q} )} )}^{T} {Y}^{( {i}_{q} )} .$$

The variance of the error in the reconstructed message in this example is

$$\begin{matrix}E ( {( x - {\hat{x}}^{p} )}^{T} ( x - {\hat{x}}^{p} ) ) = E ( {( x - \frac{1}{p} {\sum }_{q = 1}^{p} {( {U}^{( {i}_{q} )} )}^{T} {Y}^{( {i}_{q} )} )}^{T} ( x - \frac{1}{p} {\sum }_{q = 1}^{p} {( {U}^{( {i}_{q} )} )}^{T} {Y}^{( {i}_{q} )} ) ) \\ = \frac{1}{{p}^{2}} E ( {\sum }_{q = 1}^{p} {( {U}^{( {i}_{q} )} {Δ}^{( {i}_{q} )} )}^{T} {\sum }_{q = 1}^{p} {U}^{( {i}_{q} )} {Δ}^{( {i}_{q} )} ) \\ = \frac{1}{{p}^{2}} E ( {\sum }_{q = 1}^{p} {( {Δ}^{( {i}_{q} )} )}^{T} {Δ}^{( {i}_{q} )} ) \\ = \frac{1}{{p}^{2}} {\sum }_{q = 1}^{p} E ( {( {Δ}^{( {i}_{q} )} )}^{T} {Δ}^{( {i}_{q} )} ) \\ = \frac{1}{{p}^{2}} p {σ}^{2} \\ = \frac{{σ}^{2}}{p}\end{matrix}$$

Thus, in this example, as p gets larger, the variance of the error gets smaller. This implies that the more error free messages are used in the reconstruction, the more accurate the reconstruction becomes.

The error detection and correction implemented in module 214 will now be described in greater detail. If M=2k+1 orthogonal messages are generated and transmitted, and if at most k received messages contain errors, then the messages that contain large error can be detected and corrected. The error detection and correction can be achieved in O(M²) operations, that is, the number of operations has a magnitude on the order of M², which is computationally manageable. Define the channel error in the received message as e⁽ⁱ⁾=\tilde{Y}⁽ⁱ⁾−Y⁽ⁱ⁾, where \tilde{Y}⁽ⁱ⁾ is the received message of the transmitted Y⁽ⁱ⁾. Define the norm of the channel error as ∥e⁽ⁱ⁾∥=(e⁽ⁱ⁾)^{T}e⁽ⁱ⁾. Define the maximum quantization error as δ=max {∥Δ⁽ⁱ⁾∥,i=1, . . . , M}. The received error is defined to be large if ∥e⁽ⁱ⁾∥>4δ. Also define an error syndrome as

ε(i,j)=\tilde{Y}⁽ⁱ⁾−−U⁽ⁱ⁾(U^{(j)})^{T}\tilde{Y}^{(j)},∥ε(i,j)∥=ε(i,j)^{T}ε(i,j)

It is clear from the above definition that

ε(j,i)=−U^{(j)}(U⁽ⁱ⁾)^{T}ε(i,j),∥ε(i,j)∥=∥ε(j,i)∥

It can be shown that if the received message with index p contains a large error, i.e., if ∥e^{(p)}∥>4δ, then there are at least k+1 messages with index i for which ∥ε(i,p)∥>2δ. This is referred to herein as Property 1, and can be shown in the following manner. The error in the message with index p is given by e^{(p)}=\tilde{Y}^{(p)}−Y^{(p)}. Since there are at most k messages that contain errors, there are at least k+1 messages that that do not contain errors. Define the set containing all indices of messages received without error as

S_{c}={i|\tilde{Y}⁽ⁱ⁾=Y⁽ⁱ⁾}

Then, the cardinality of S_{c}, which is the number of indices in S_{c}, satisfies |S_{c}|≧k+1. Let i∈S_{c}, then

$$ɛ ( i , p ) = {\tilde{Y}}^{( i )} - {{U}^{( i )} ( {U}^{( p )} )}^{T} {\tilde{Y}}^{( p )} = {Y}^{( i )} - {{U}^{( i )} ( {U}^{( p )} )}^{T} ( {Y}^{( p )} + {e}^{( p )} ) = {U}^{( i )} x + {Δ}^{( i )} - {{U}^{( i )} ( {U}^{( p )} )}^{T} ( {U}^{( p )} x + {Δ}^{( p )} + {e}^{( p )} ) = {Δ}^{( i )} - {{U}^{( i )} ( {U}^{( p )} )}^{T} {Δ}^{( p )} - {{U}^{( i )} ( {U}^{( p )} )}^{T} {e}^{( p )}$$

$$‖ ɛ ( i , p ) ‖ \geq ‖ {{U}^{( i )} ( {U}^{( p )} )}^{T} {e}^{( p )} ‖ - ‖ {Δ}^{( i )} - {{U}^{( i )} ( {U}^{( p )} )}^{T} {Δ}^{( p )} ‖ \geq ‖ {e}^{( p )} ‖ - 2 δ > 2 δ$$

The above shows that any index i in S_{c} has the property ∥ε(i,p)∥>2δ. Since there are at least k+1 indices in S_{c}, this proves Property 1.

Again assume that M=2k+1 and assume at most k received messages contain errors. If a received message with index p contains no error, then there are at most k messages with index i for which ∥ε(i,p)∥>2δ. This is referred to herein as Property 2, and can be shown in the following manner. Since the message with index p has no error, \tilde{Y}^{(p)}=Y^{(p)}. Let i∈S_{c}, then

$$ɛ ( i , p ) = {\tilde{Y}}^{( i )} - {{U}^{( i )} ( {U}^{( p )} )}^{T} {\tilde{Y}}^{( p )} = {Y}^{( i )} - {{U}^{( i )} ( {U}^{( p )} )}^{T} {Y}^{( p )} = {U}^{( i )} x + {Δ}^{( i )} - {{U}^{( i )} ( {U}^{( p )} )}^{T} ( {U}^{( p )} x + {Δ}^{( p )} ) = {Δ}^{( i )} - {{U}^{( i )} ( {U}^{( p )} )}^{T} {Δ}^{( p )}$$

$$‖ ɛ ( i , p ) ‖ = ‖ {Δ}^{( i )} - {{U}^{( i )} ( {U}^{( p )} )}^{T} {Δ}^{( p )} ‖ \leq 2 δ$$

Therefore, there are at least k+1 messages with index i for which ∥ε(i,p)∥≦2δ. Since there are a total of 2k+1 messages, there are no more than k messages with index i for which ∥ε(i,p)∥≦2δ. This proves Property 2.

Error detection based on the above principles is implemented in module 214 as follows. For M=2k+1 received messages \tilde{Y}⁽ⁱ⁾, i=1, . . . , M, compute the syndromes ∥ε(i,j)∥,i,j=1, . . . , M. Note the symmetry ∥ε(i,j)∥=∥ε(j,i)∥. Therefore, only a total number of M(M+1)/2 syndromes need to be computed. Then, find all messages with index p, such that there are at least k+1 syndromes having ∥ε(i,p)∥>2δ. Any message which has a large error must be one of such messages, according to Property 1. Furthermore, any such message must contain an error, because, according to Property 2, a message without error can have at most k syndromes with ∥ε(i,p)∥>2δ. Formally define

S_{L}={p|there are at least k+1 messages with index i such that ∥ε(i,p)∥>2δ}

Then, the sets S_{L} and S_{c} have no intersection, i.e., S_{L}∩S_{c}=φ. All messages with large errors must have their index in S_{L}, i.e. if ∥e⁽ⁱ⁾∥>4δ, then i∈S_{L}. Also, all messages with an index not in S_{L} either have no error, or have small errors, since if i∉S_{L}, then ∥e⁽ⁱ⁾∥≦4δ.

The received messages with large errors are detected using the previous algorithm and their indices are collected in the set S_{L}. These messages can be corrected using the following algorithm, also implemented in module 214.

Let P=∥S_{L}∥, the number of indices in S_{L}. For each detected message with index p∈S_{L}, the corrected message is defined by

$${\hat{Y}}^{( p )} = \frac{1}{M - P} {\sum }_{i ∉ {S}_{L}} {{U}^{( p )} ( {U}^{( i )} )}^{T} {\tilde{Y}}^{( i )}$$

The above corrected message may not equal the transmitted message Y^{(p)} exactly, but the purpose is not to find the transmitted messages; the purpose is rather to reconstruct the original message.

The error in the corrected message as compared to the original message is

$${\hat{Y}}^{( p )} - {U}^{( p )} x = \frac{1}{M - P} ( {\sum }_{i ∉ {S}_{L}} {{U}^{( p )} ( {U}^{( i )} )}^{T} {Δ}^{( i )} + {\sum }_{i ∉ {S}_{L} ⋃ {S}_{c}} {{U}^{( p )} ( {U}^{( i )} )}^{T} {e}^{( i )} )$$

$$E ( {( {\hat{Y}}^{( p )} - {U}^{( p )} x )}^{T} ( {\hat{Y}}^{( p )} - {U}^{( p )} x ) ) \leq \frac{1}{{( 2 k + 1 - P )}^{2}} ( ( 2 k + 1 - P ) {σ}^{2} + ( k - P ) 16 {δ}^{2} ) \leq \frac{1}{2 k + 1 - P} {σ}^{2} + \frac{16 ( k - P )}{{( 2 k + 1 - P )}^{2}} {δ}^{2}$$

The above error can be made arbitrarily small by increasing k.

After error detection, the original message may be approximated by reconstruction:

$$\hat{x} = \frac{1}{2 k + 1 - P} {\sum }_{i ∉ {S}_{L}} {( {U}^{( i )} )}^{T} {\tilde{Y}}^{( i )}$$

The above reconstructed message \hat{x} may not be equal to the original message x, but it is a good approximation of the original message. The error in the reconstructed message \hat{x}, as compared to the original message x, is the same as given previously, that is

$$E ( {( \hat{x} - x )}^{T} ( \hat{x} - x ) ) \leq \frac{1}{2 k + 1 - P} {σ}^{2} + \frac{16 ( k - P )}{{( 2 k + 1 - P )}^{2}} {δ}^{2}$$

which again can be made arbitrarily small by increasing k.

Note that there is no gain of accuracy to use the corrected messages Ŷ⁽ⁱ⁾, i∈S_{L}, in place of the estimated messages \tilde{Y}⁽ⁱ⁾,i∈S_{L}, for the exemplary reconstruction and error correction techniques described above. However, it is also possible to use other reconstruction techniques, such as those described in the above-cited V. Goyal reference, and an additional gain in accuracy may be achieved by using the corrected messages in such reconstruction.

As noted previously, the above-described orthogonal multiple description coding techniques are advantageous in that the redundancy introduced by the use of orthogonal matrices to generate the multiple descriptions can be used not only to improve signal reconstruction quality, but also to detect and correct errors in the received signal. This avoids the need to dedicate additional bandwidth for FEC and CRC, thereby ensuring that there will be no wasted bandwidth in the absence of errors, while also providing graceful degradation in the presence of errors.

A variety of alternative embodiments of the FIG. 2 system are possible. For example, one such embodiment may include only modules 202, 204, 214 and 216, with the serialization and interleaving functionality eliminated. In such an arrangement, the multiple descriptions at the output of the quantizer 204 may be transmitted over respective separate parallel channels, rather than serialized and interleaved.

It is also possible for a given embodiment to include only error detection capability, rather than both error detection and error correction capability as in the FIG. 2 embodiment. A module corresponding generally to module 214 but configured only to detect errors is an example of what is more generally referred to herein as “error protection circuitry.” Such circuitry is also intended to encompass module 214.

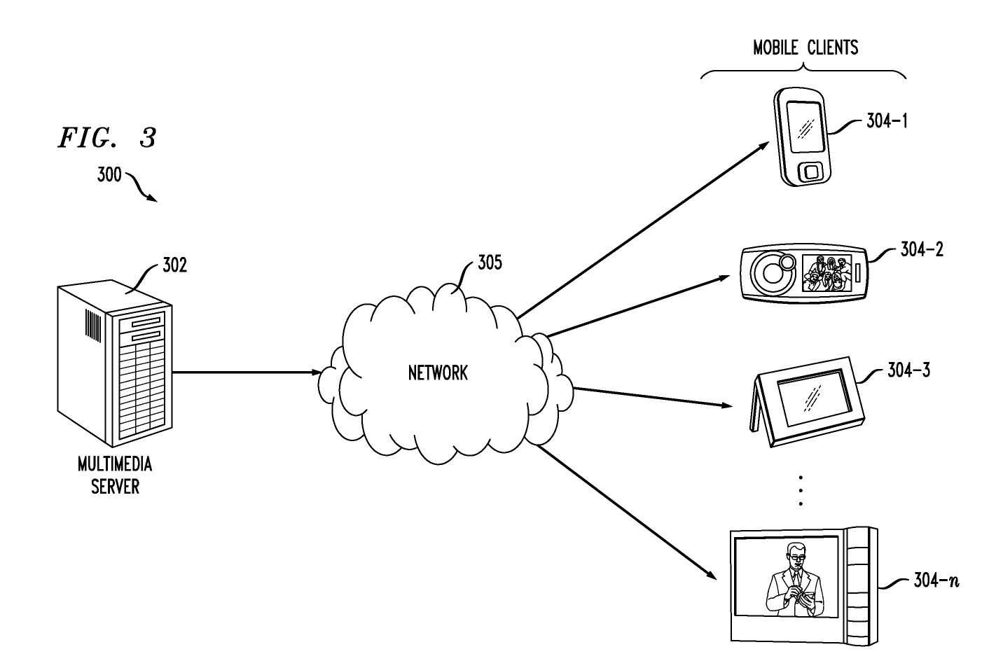

FIG. 3 shows another example of a communication system 300 comprising a multimedia server 302 that implements orthogonal multiple description coding. The server 302 is assumed to include an orthogonal multiple description encoder comprising modules 202, 204 and 206 as previously described. The orthogonal multiple description encoder may be implemented by modifying an otherwise conventional video encoder to incorporate modules 202, 204 and 206. The multimedia server utilizes this encoder to generate multiple descriptions of a video signal in the manner previously described. Those descriptions are transmitted over a network 305 to mobile client devices which in this example include devices 304-1, 304-2, 304-3 and 304-4. Each such device is assumed to include an orthogonal multiple description decoder comprising modules 212, 214 and 216. These decoders may each be implemented by modifying an otherwise conventional video decoder to incorporate modules 212, 214 and 216. The network 305 may comprise a multicast or broadcast network used to transmit video from the multimedia server 302 to the multiple client devices 304.

The system 300 can also or alternatively use orthogonal multiple description coding to transmit images, voice, audio, data or any other type of signal.

As indicated previously, embodiments of the present invention may be implemented at least in part in the form of one or more software programs that are stored in a memory or other computer-readable medium of a transmitter or receiver of a communication system. System components such as the modules 202, 204, 206, 212, 214 and 216 may be implemented at least in part using software programs. Of course, numerous alternative arrangements of hardware, software or firmware in any combination may be utilized in implementing these and other system elements in accordance with the invention. For example, embodiments of the present invention may be implemented in one or more field-programmable gate arrays (FPGAs), application-specific integrated circuits (ASICs) or other types of integrated circuit devices, in any combination. Such integrated circuit devices, as well as portions or combinations thereof, are examples of “circuitry” as the latter term is used herein.

It should again be emphasized that the embodiments described above are for purposes of illustration only, and should not be interpreted as limiting in any way. Other embodiments may use different types of communication system components, device configurations, and communication media, depending on the needs of the particular multiple description coding application. Alternative embodiments may therefore utilize the techniques described herein in other contexts in which it is desirable to implement efficient multiple description coding. Also, it should also be noted that the particular assumptions made in the context of describing the illustrative embodiments should not be construed as requirements of the invention. The invention can be implemented in other embodiments in which these particular assumptions do not apply. These and numerous other alternative embodiments within the scope of the appended claims will be readily apparent to those skilled in the art.

What is claimed is:

1. An apparatus comprising:
a multiple description encoder, the encoder comprising:
orthogonal multiple description generation circuitry configured to produce multiple descriptions of a given signal by processing the signal using respective ones of a plurality of orthogonal matrices;
wherein each of the multiple descriptions is generated as a function of said signal and a corresponding one of the plurality of orthogonal matrices.

2. The apparatus of claim 1 wherein the multiple descriptions are generated by multiplying said signal by respective ones of the plurality of orthogonal matrices.

3. The apparatus of claim 1 wherein the signal comprises a vector x of dimension N and the orthogonal multiple description generation circuitry is configured to generate M descriptions of the vector x, and wherein the orthogonal matrices comprise orthogonal matrices U⁽ⁱ⁾, i=1, 2, . . . , M of dimension N×N, where
(U⁽ⁱ⁾)^{T}U⁽ⁱ⁾=U⁽ⁱ⁾(U⁽ⁱ⁾)^{T}=I,i=1, . . . ,M.

4. The apparatus of claim 3 wherein the M descriptions of the vector x comprise M descriptions y⁽ⁱ⁾ that are generated by applying respective ones of the orthogonal matrices to the vector x in accordance with the following equation:
y⁽ⁱ⁾=U⁽ⁱ⁾x,i=1, . . . ,M.

5. The apparatus of claim 3 wherein the orthogonal matrices are given by:
$${U}^{( 1 )} = I - \frac{2}{{( {v}^{( 1 )} )}^{T} {v}^{( 1 )}} {{v}^{( 1 )} ( {v}^{( 1 )} )}^{T}$$
$${U}^{( i )} = {U}^{( i - 1 )} ( I - \frac{2}{{( {v}^{( i )} )}^{T} {v}^{( i )}} {{v}^{( i )} ( {v}^{( i )} )}^{T} ) , \\ i = 2 , … M$$
where rᵢ,i=1, 2, . . . , NM is a sequence of random numbers in a specified interval, and
$${v}^{( i )} = [ \begin{matrix}{r}_{( i - 1 ) N + 1} \\ {r}_{( i - 1 ) N + 2} \\ ⋮ \\ {r}_{( i - 1 ) N + N}\end{matrix} ] , \\ i = 1 , … , M .$$

6. The apparatus of claim 3 wherein the orthogonal matrices are given by:
U=[u⁽⁰⁾,u⁽¹⁾, . . . ,u^{(N-1)}].
where u⁽ⁱ⁾, i=0, . . . , N−1 is a set of orthonormal vectors generated by applying an orthogonalization process to a sequence of vectors v⁽ⁱ⁾,i=0, 1 . . . , of length N, whose components are random numbers.

7. The apparatus of claim 1 further comprising quantization circuitry having inputs coupled to respective outputs of the generation circuitry and being configured to quantize the multiple descriptions.

8. The apparatus of claim 7 wherein the quantization circuitry comprises a scalar quantizer.

9. The apparatus of claim 7 wherein the quantized multiple descriptions are given by:
Y⁽ⁱ⁾=Q(y⁽ⁱ⁾)=Q(U⁽ⁱ⁾x),i=1, . . . ,M
where the signal comprises a vector x, U⁽ⁱ⁾ denotes one of the orthogonal matrices, M denotes the number of multiple descriptions of the signal that are generated, and Q is a quantization function.

10. The apparatus of claim 1 further comprising serialization circuitry having inputs coupled to respective outputs of the generation circuitry and being configured to serialize the multiple descriptions for transmission over a communication medium.

11. The apparatus of claim 10 wherein the serialization circuitry further comprises interleaving circuitry for interleaving said descriptions in conjunction with said serialization of said multiple descriptions.

12. An integrated circuit comprising the multiple description encoder of claim 1.

13. A multiple description encoding method comprising the steps of:
obtaining a given signal; and
producing multiple descriptions of the signal by processing the signal using respective ones of a plurality of orthogonal matrices;
wherein each of the multiple descriptions is generated as a function of said signal and a corresponding one of the plurality of orthogonal matrices.

14. A computer-readable storage medium having embodied therein executable program code that when executed by a processor of a processing device causes the device to perform the steps of the method of claim 13.

15. An apparatus comprising:
a multiple description decoder, the decoder comprising:
reconstruction circuitry configured to receive respective multiple descriptions of a given signal, and to generate an estimate of the signal by applying orthogonal matrices to respective ones of the multiple descriptions.

16. The apparatus of claim 15 wherein the signal comprises a vector x and the reconstruction circuitry is configured to generate an estimate \hat{x}^{p} of the vector x using p of the multiple descriptions of x in accordance with the following equation:
$${\hat{x}}^{p} = \frac{1}{p} {\sum }_{q = 1}^{p} {( {U}^{( {i}_{q} )} )}^{T} {Y}^{( {i}_{q} )} ,$$
where Y⁽ⁱ^{₁}⁾, Y⁽ⁱ^{₂}⁾, . . . , Y⁽ⁱ^{ₚ}⁾ denote respective ones of the p descriptions, U⁽ⁱ^{₁}⁾, U⁽ⁱ^{₂}⁾, . . . , U⁽ⁱ^{_{q}}⁾ denote respective ones of the orthogonal matrices, and T denotes a transpose operation.

17. The apparatus of claim 15 wherein the multiple descriptions are received by the reconstruction circuitry from error protection circuitry, the error protection circuitry being configured to detect particular ones of the multiple descriptions having errors above a specified threshold.

18. The apparatus of claim 17 wherein the signal comprises a vector x and the reconstruction circuitry is configured to generate an estimate \hat{x} of the vector x in accordance with the following equation:
$$\hat{x} = \frac{1}{M - P} {\sum }_{i ∉ {S}_{L}} {( {U}^{( i )} )}^{T} {\tilde{Y}}^{( i )} ,$$
wherein S_{L} denotes a set containing said detected multiple descriptions having errors above the specified threshold, P=|S_{L}| denotes the number of detected multiple descriptions in the set S_{L}, U⁽ⁱ⁾,i=1, 2, . . . , M denote the orthogonal matrices, \tilde{Y}⁽ⁱ⁾,i=1, 2, . . . , M denote the multiple descriptions, and T denotes a transpose operation.

19. The apparatus of claim 18 wherein the error protection circuitry is further configured to correct at least one of the detected multiple descriptions having errors above the specified threshold in accordance with the following equation:
$${\hat{Y}}^{( p )} = \frac{1}{M - P} {\sum }_{i ∉ {S}_{L}} {{U}^{( p )} ( {U}^{( i )} )}^{T} {\tilde{Y}}^{( i )} ,$$
where p denotes a particular one of the detected multiple descriptions in the set S_{L} and Ŷ^{(p)} denotes a corresponding corrected one of the multiple descriptions.

20. An integrated circuit comprising the multiple description decoder of claim 15.

21. A multiple description decoding method comprising the steps of:
receiving estimates of multiple descriptions of a given signal; and
reconstructing an estimate of the signal by applying orthogonal matrices to respective ones of the estimates of the multiple descriptions.

22. A computer-readable storage medium having embodied therein executable program code that when executed by a processor of a processing device causes the device to perform the steps of the method of claim 21.
